(19) United States
(12) Patent Application Publication
(10) Pub. No.: US 2012/0331518 A1
(43) Pub. Date: Dec. 27, 2012

(54) FLEXIBLE SECURITY TOKEN FRAMEWORK

(75) Inventor: Jong Lee, Pleasanton, CA (US)

(73) Assignee: SALESFORCE.COM, INC., San Francisco, CA (US)

(21) Appl. No.: 13/279,900

(22) Filed: Oct. 24, 2011

Related U.S. Application Data
(60) Provisional application No. 61/500,422, filed on Jun. 23, 2011.

(51) Int. Cl. G06F 21/00; G06F 17/00

(52) U.S. Cl. 726/1

(57) ABSTRACT

A computer-implemented server system includes or supports applications that use security tokens. The server system includes a security token module to create token types for use with the applications, to generate security tokens corresponding to created token types, and to enforce token use policies for generated security tokens. The server system also includes a database to store security tokens for the token module. The token module accommodates creation of different token types having different token formats and different token use policies, based on obtained values of a plurality of token configuration variables. The token module generates security tokens in accordance with the different token formats, and enforces the different token use policies when processing incoming security tokens.

### CROSS-REFERENCE TO RELATED APPLICATION(S)

This application claims the benefit of U.S. provisional patent application Ser. No. 61/500,422, filed Jun. 23, 2011, the content of which is incorporated by reference herein.

### TECHNICAL FIELD

Embodiments of the subject matter described herein relate generally to data processing systems and techniques, such as systems and processes that use a common network-based platform to support applications executing on behalf of multiple tenants. More particularly, embodiments of the subject matter relate to a centralized security token module and framework deployed in a computer-based system to configure, generate, and validate security tokens having different properties, characteristics, and policies associated therewith.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system wherein a single hardware and software platform simultaneously supports multiple user groups (also referred to as “organizations” or “tenants”) from a common data store. The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

A multi-tenant architecture (and other computing systems) may issue, maintain, and otherwise utilize security tokens for any number of reasons, e.g., for user authentication, for identity confirmation procedures, and for password protection of data. Different types of security tokens may be utilized for different applications or protocols supported by the computing system. For example, a four digit code (such as a personal identification number or “PIN”) represents a simple and somewhat vulnerable security token. In contrast, a fifty character case sensitive string with numbers, letters, and special characters represents a complex and strong security token. The specific type and number of different security tokens may vary from one tenant to another and/or from one user of a particular tenant to another user of the same tenant.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary multi-tenant data processing system;

FIG. 2 is a block diagram of an exemplary security token framework suitable for deployment in a computing system such as the multi-tenant data processing system shown in FIG. 1;

FIG. 3 is a block diagram of an exemplary security token module suitable for deployment in a computing system such as the multi-tenant data processing system shown in FIG. 1;

FIG. 4 is a table that illustrates exemplary security token configuration variables that define the token format and token use policies for different token types; and

FIG. 5 is a flow chart that illustrates an exemplary process related to the configuration, creation, and management of security tokens.

### DETAILED DESCRIPTION

The exemplary embodiments presented here relate to a security token framework and related techniques, methodologies, procedures, and technology for defining, configuring, generating, deploying, and validating security tokens. The described subject matter can be implemented in the context of any computer-implemented system, such as a software-based system, a database system, a multi-tenant environment, or the like. Moreover, the described subject matter could be implemented in connection with two or more separate and distinct computer-implemented systems that cooperate and communicate with one another.

In accordance with one exemplary embodiment described below, a computer based system such as a multi-tenant architecture includes a centralized security token framework, processing module, or platform that can be used to service a plurality of different tenants, a plurality of different end users, and a plurality of different tenant applications. The security token framework obtains token-defining data (e.g., declarations, parameters, descriptors, configuration files) and generates token types that adhere to the properties, characteristics, and policies corresponding to the token-defining data. After configuring a new token type, the security token framework generates security tokens of the new type as needed, enforces any use-based policies associated with that token type, and validates incoming tokens when needed.

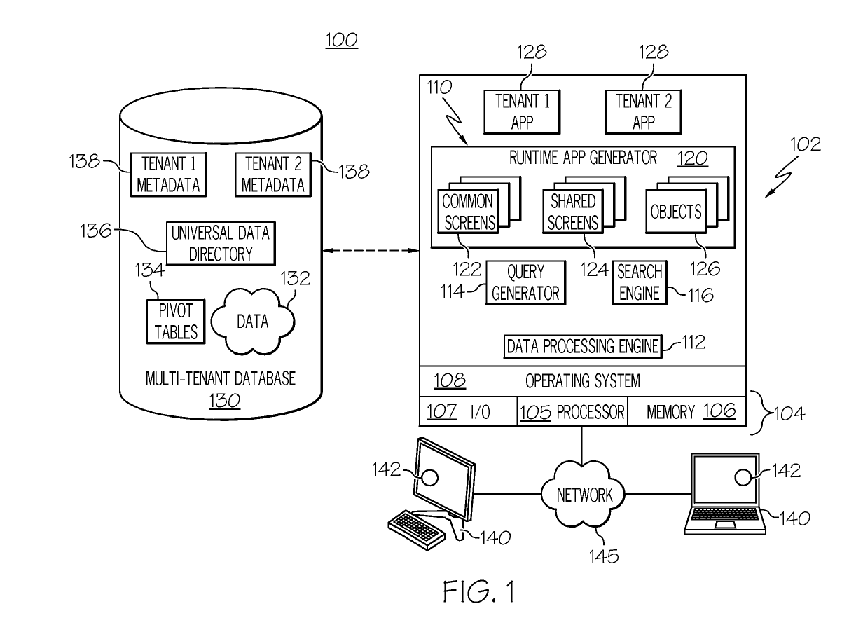

Turning now to FIG. 1, an exemplary multi-tenant application system 100 suitably includes a server 102 that dynamically creates virtual applications 128 based upon data 132 from a common database 130 that is shared between multiple tenants. Data and services generated by the virtual applications 128 are provided via a network 145 to any number of user devices 140, as desired. Each virtual application 128 is suitably generated at run-time using a common application platform 110 that securely provides access to the data 132 in the database 130 for each of the various tenants subscribing to the system 100. In accordance with one non-limiting example, the system 100 may be implemented in the form of a multi-tenant customer relationship management system that can support any number of authenticated users of multiple tenants.

A “tenant” or an “organization” generally refers to a group of users that shares access to common data within the database 130. Tenants may represent customers, customer departments, business or legal organizations, and/or any other entities that maintain data for particular sets of users within the system 100. Although multiple tenants may share access to the server 102 and the database 130, the particular data and services provided from the server 102 to each tenant can be securely isolated from those provided to other tenants. The multi-tenant architecture therefore allows different sets of users to share functionality without necessarily sharing any of the data 132.

The database 130 is any sort of repository or other data storage system capable of storing and managing the data 132 associated with any number of tenants. The database 130 may be implemented using any type of conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

The data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired.

Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants. Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

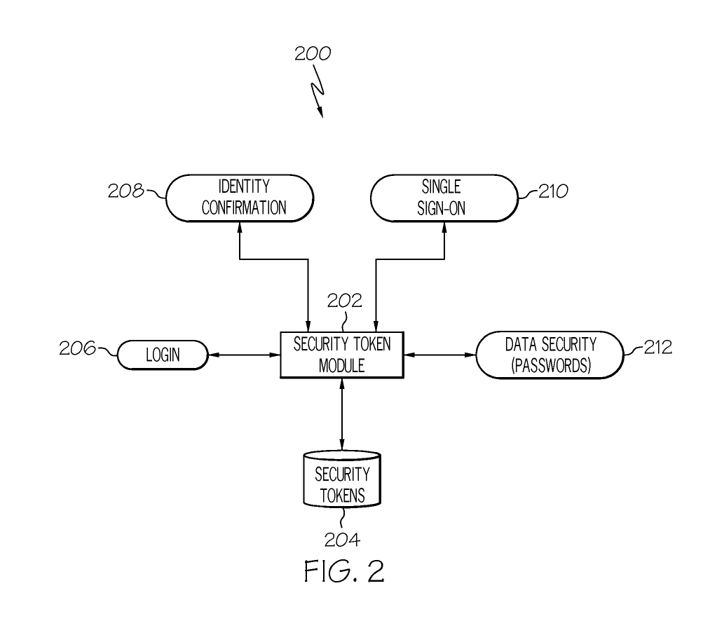

For the exemplary embodiment described in more detail below with reference to FIGS. 2-6, the database 130 is used to store security tokens generated and maintained by a centralized security token framework. Accordingly, the data 132 may include different types of security tokens that may be used across a plurality of different tenants. Moreover, metadata 136 within the UDD and/or the tenant-specific metadata 138 may be descriptive of, or otherwise associated with, security tokens generated and maintained by the security token framework.

The server 102 is implemented using one or more actual and/or virtual computing systems that collectively provide the dynamic application platform 110 for generating the virtual applications 128. The server 102 operates with any sort of conventional processing hardware 104, such as a processor 105, memory 106, input/output features 107 and the like. The processor 105 may be implemented using one or more of microprocessors, microcontrollers, processing cores and/or other computing resources spread across any number of distributed or integrated systems, including any number of “cloud-based” or other virtual systems. The memory 106 represents any non-transitory short or long term storage capable of storing programming instructions for execution on the processor 105, including any sort of random access memory (RAM), read only memory (ROM), flash memory, magnetic or optical mass storage, and/or the like. The server 102 typically includes or cooperates with some type of computer-readable media, where a tangible computer-readable medium has computer-executable instructions stored thereon. The computer-executable instructions, when read and executed by the server 102, cause the server 102 to perform certain tasks, operations, functions, and processes described in more detail herein. In this regard, the memory 106 may represent one suitable implementation of such computer-readable media. Alternatively or additionally, the server 102 could receive and cooperate with computer-readable media (not separately shown) that is realized as a portable or mobile component or platform, e.g., a portable hard drive, a USB flash drive, an optical disc, or the like.

The input/output features 107 represent conventional interfaces to networks (e.g., to the network 145, or any other local area, wide area or other network), mass storage, display devices, data entry devices and/or the like. In a typical embodiment, the application platform 110 gains access to processing resources, communications interfaces and other features of the processing hardware 104 using any sort of conventional or proprietary operating system 108. As noted above, the server 102 may be implemented using a cluster of actual and/or virtual servers operating in conjunction with each other, typically in association with conventional network communications, cluster management, load balancing and other features as appropriate.

The application platform 110 is any sort of software application or other data processing engine that generates the virtual applications 128 that provide data and/or services to the user devices 140. The virtual applications 128 are typically generated at run-time in response to queries received from the user devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the user devices 140. The virtual applications 128 created by tenants are typically constructed in accordance with the tenant-specific metadata 138, which describes the particular tables, reports, interfaces and/or other features of the particular application. In various embodiments, each virtual application 128 generates dynamic web content that can be served to a browser or other client program 142 associated with its user device 140, as appropriate. As used herein, such web content represents one type of resource, data, or information that may be protected or secured using various user authentication procedures.

The runtime application generator 120 suitably interacts with the query generator 114 to efficiently obtain multi-tenant data 132 from the database 130 as needed. In a typical embodiment, the query generator 114 considers the identity of the user requesting a particular function, and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user that initiated the request.

The data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc. In certain embodiments, the data processing engine 112 and the processor 105 cooperate in an appropriate manner to perform and manage the various security token configuration, generation, maintenance, and validation techniques, processes, and methods described in more detail below with reference to FIGS. 2-6.

In operation, developers use the application platform 110 to create data-driven virtual applications 128 for the tenants that they support. Such virtual applications 128 may make use of interface features such as tenant-specific screens 124, universal screens 122 or the like. Any number of tenant-specific and/or universal objects 126 may also be available for integration into tenant-developed virtual applications 128. The data 132 associated with each virtual application 128 is provided to the database 130, as appropriate, and stored until it is requested or is otherwise needed, along with the metadata 138 that describes the particular features (e.g., reports, tables, functions, etc.) of that particular tenant-specific virtual application 128.

The data and services provided by the server 102 can be retrieved using any sort of personal computer, mobile telephone, portable device, tablet computer, or other network-enabled user device 140 that communicates via the network 145. Typically, the user operates a conventional browser or other client program 142 to contact the server 102 via the network 145 using, for example, the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. The query generator 114 suitably obtains the requested data 132 from the database 130 as needed to populate the tables, reports or other features of the particular virtual application 128. As noted above, the virtual application 128 may contain Java, ActiveX, or other content that can be presented using conventional client software running on the user device 140; other embodiments may simply provide dynamic web or other content that can be presented and viewed by the user, as desired.

FIG. 2 is a block diagram of an exemplary security token framework 200 suitable for deployment in a computer-implemented server system such as the system 100 shown in FIG. 1. This generalized exemplary embodiment of the security token framework 200 includes two primary elements, namely, a security token module 202 and a database 204. In practice, the security token module 202 may be realized as a functional or logical processing element implemented with suitably written software code. Moreover, the security token module 202 may be deployed in connection with a single piece of hardware or in a distributed manner across multiple hardware devices. In the exemplary embodiment presented here, a single instantiation of the security token module 202 is provided as a centralized module to support a plurality of different applications, tenants, and users of the host system. In alternate embodiments, multiple instantiations of the security token module 202 could be deployed in the host system if so desired.

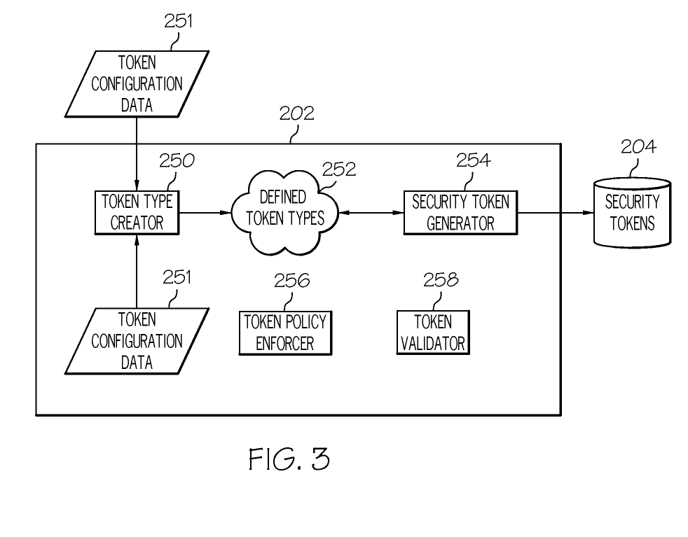

FIG. 3 is a block diagram of an exemplary embodiment of the security token module 202. The security token module 202 may include a token type creator 250 that is suitably configured to create token types for use with at least one application, feature, function, protocol, or process (collectively referred to as “applications”) of the host system. In practice, the security token module 202 can create and configure any number of different token types as needed to support the operation of the host system. As described in a more fulsome manner below, the token type creator 250 creates the token types in response to certain token configuration data 251, which may originate from or otherwise be provided by a source “external” to the security token module 202 and/or a source “internal” to the security token module 202. FIG. 3 depicts the defined token types 252 that are maintained and managed by the security token module 202. In practice, the data that actually defines the different token types 252 may be stored in the database 204; the defined token types 252 are depicted as part of the security token module 202 for ease of understanding.

After creating a given token type, a security token generator 254 of the security token module 202 is able to generate security tokens of that particular type in an ongoing manner as needed. The database 204 cooperates with the security token generator 254, and is suitably configured to store security tokens generated by the security token module 202. The security tokens stored for the security token module 202 can be subsequently used for validation of incoming (e.g., user-entered) security tokens in connection with one or more of the supported applications. As mentioned above for the exemplary implementation depicted in FIG. 1, the database 204 may be implemented in the multi-tenant database 130 of the system 100 to support a plurality of different tenants.

FIG. 2 schematically depicts several applications that may cooperate with or rely on the security token module 202. Each of the illustrated applications utilize, process, or handle security tokens from time to time. For example, the security token module 202 may create token types and generate security tokens for use by a login application 206, an identity confirmation application 208, a single sign-on application 210, and/or a data security application 212. In practice, the login application 206 and the single sign-on application 210 may handle user passwords, which represent one type of security token in the context of this description. The identity confirmation application 208 may also process user passwords, and it may require one or more “internal” or “hidden” security tokens that are not exposed to the end user. Similarly, the data security application 212 may process codes, keys, or passwords that are utilized to unlock or gain access to protected data, documents, files, or resources. It should be understood that the security token module 202 can work with only one application or any number of different applications if so desired, and that the four specific applications shown in FIG. 2 are not meant to be exhaustive or to otherwise limit the scope or breadth of the described subject matter in any way.

Notably, the different applications supported by the security token module 202 will typically call for security tokens having different characteristics, properties, parameters, formatting, and the like. For example, the login application 206 might utilize security tokens (e.g., user passwords) that must be between five and ten characters long and without any special characters, and the identity confirmation application 208 might require security tokens that must be fifty characters long and must include at least five special characters. Moreover, the different applications may specify different token use policies that apply to the security tokens handled by the applications. For example, the login application 206 may designate an undefined lifespan for a user password, or it may specify an expiration period for a user password. As another example, the single sign-on application 210 may have a policy in place that limits the number of failed attempts at entering a user password.

Accordingly, as used herein a “token type” will have a defined and designated token format that specifies certain requirements and rules that govern the format and content of all security tokens having that particular token type. In addition, a “token type” will have a defined and designated set of token use policies that relate to the manner in which security tokens of that particular token type are generated, maintained, managed, and otherwise processed. In practice, the specific token type used for a given application may vary depending upon the desired level of security, the number of different applications, the number of different end users, system administrator preferences, user preferences, compliance with standard protocols, etc.

Theoretically, the security token module 202 can define and handle any number of different token types, which may be used concurrently by the various applications of the host system. In certain embodiments, however, there may be a practical limit on the number of different token types that can be managed by the security token module 202. In this regard, the exemplary embodiment described herein creates token types based on the values of a limited number of token configuration variables. Accordingly, there might be a mathematical limit on the number of different possible token types that can be created from a set of variables, especially if the variables themselves have a restricted domain for their values.

In a multi-tenant server architecture, the security token module 202 could create at least one token type that is used across at least two of the different tenants of the host system. For example, the same login application 206 (along with its authentication policies and protocols) might be used across all tenants supported by the security token framework 200 and, therefore, a common token type could be defined and utilized for the login application 206. On the other hand, the security token module 202 could create a token type that is exclusively used by only one tenant, or that is exclusively used by only one application. The flexible and accommodating nature of the security token framework 200 supports these different scenarios, along with other possible scenarios.

As mentioned above, the security token module 202 can create new token types when instructed to do so, generate security tokens for any new token type, and perform any number of processes to handle and manage the use of the security tokens maintained at the host system and to handle and manage incoming security tokens received at the host system. For example, the security token module 202 may include a token policy enforcer 256 (see FIG. 3) that enforces the defined token use policies for any new token type. As another example, the security token module 202 may include a token validator 258 that is suitably configured to perform validation, authentication, and related procedures to confirm whether or not a received security token is valid and acceptable.

Notably, the security token module 202 is flexibly and generically configured to accommodate the creation of a plurality of different token types (which may have different token formats and may have different token use policies). Consequently, the security token module can quickly and easily create, generate, and deploy a new “suite” of security tokens to support a new or modified application of the host system, without requiring a significant upgrade to the primary system source code or primary system operating modules.

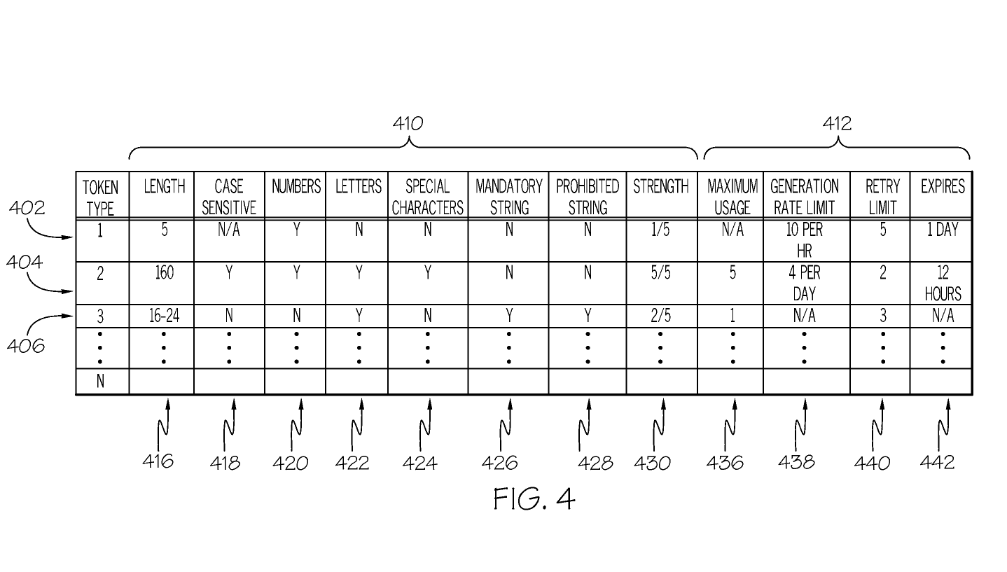

As described above, the security token module 202 preferably generates security tokens in accordance with the different token formats defined by the configured token types, and also enforces the different token use policies when processing incoming security tokens of the different token types. Accordingly, the creation of the different token types represents a preliminary step that establishes the rules and protocols that apply to a given class, set, or category of security tokens. In certain embodiments, the security token module 202 creates token types in response to specified values for a plurality of token configuration variables. The token configuration variables may be conveyed in suitable configuration data that defines or otherwise indicates a plurality of token format settings and a plurality of token use policy settings for the particular token type. In this regard, FIG. 4 is a table that illustrates exemplary security token configuration variables that define the token format and token use policies for different token types.

Although any number of distinct token types may be supported by the security token framework 200, FIG. 4 shows the configuration values for three exemplary token types 402, 404, 406 (labeled Token Type 1, Token Type 2, and Token Type 3). For clarity and ease of description, FIG. 4 depicts the configuration variables grouped into token format variables 410 and token use policy variables 412. Although any number of different token format variables 410 can be defined, this example utilizes the following token format variables 410, without limitation: a token length variable 416; a case sensitivity variable 418; a “numbers permitted” variable 420; a “letters permitted” variable 422; a “special characters permitted” variable 424; a mandatory character string variable 426; a prohibited character string variable 428; and a minimum strength variable 430. Although any number of different token use policy variables 412 can be defined, this example uses the following token use policy variables 412, without limitation: a “maximum number of uses” variable 436; a generation rate limit variable 438; a “maximum number of failed attempts” variable 440, and an expiration variable 442.

The token length variable 416 relates to the specified character length or range of allowable lengths for the token type. In this regard, the token length variable 416 may be used to specify one or more distinct lengths, a minimum length, a maximum length, a minimum and maximum length, an unrestricted length, or the like. For the examples shown in FIG. 4, all security tokens of the Token Type 1 must have a length of five characters, all security tokens of the Token Type 2 must have a length of 160 characters, and all security tokens of the Token Type 3 must have a length between 16 and 24 characters.

The case sensitivity variable 418 designates whether or not security tokens of the token type are case sensitive. In practice, the case sensitivity variable 418 may simply have two states to indicate “case sensitive” and “not case sensitive” (and possibly an additional “null” or “not applicable” state). For the examples shown in FIG. 4, case sensitivity is not applicable to the security tokens of the Token Type 1 because Token Type 1 corresponds to numerical tokens. However, the security tokens of the Token Type 2 are case sensitive, and the security tokens of the Token Type 3 are not case sensitive.

The “numbers permitted” variable 420, the “letters permitted” variable 422, and the “special characters permitted” variable 424 are similar in that they designate whether or not certain character types are allowed (equivalently, these variables could indicate whether or not certain character types are prohibited, mandatory, or the like). In practice, each of these variables 420, 422, 424 may have two states to indicate whether or not the respective character type is permitted in the security tokens of the defined type. For the examples shown in FIG. 4, the Token Type 1 permits numbers but does not permit letters or special characters. In other words, the Token Type 1 corresponds to a numerical security token. In contrast, the Token Type 2 permits numbers, letters, and special characters, and the Token Type 3 permits letters but does not permit numbers or special characters. Accordingly, security tokens of the Token Type 3 will include letters only.

The mandatory character string variable 426 designates whether or not the security tokens are required to contain any particular string (or strings) of characters. For example, an application may specify that all security tokens received for user authentication purposes must begin or end with a predefined character string (such as “mmT65”). If one or more mandatory strings are required, then the mandatory character string variable 426 may also be used to specify the character string(s) to be used, the character position or location in the security token, and/or other information necessary to implement the mandatory string rules. Notably, the mandatory character string variable 426 could point to another variable maintained by the system such that a mandatory string is defined or otherwise influenced by data that need not be entered. For instance, the mandatory character string variable 426 might link to a registered user name, an entity name, a tenant name, or the like. For the examples shown in FIG. 4, the Token Types 1 and 2 do not call for any mandatory strings. The Token Type 3, however, does require at least one mandatory character string.

Conversely, the prohibited character string variable 428 designates whether or not a certain string (or strings) of characters are prohibited. For example, an application may prohibit the use of simple strings such as “123” or “abcd” to ensure that security tokens are generated with at least a minimum level of complexity. If one or more mandatory strings are prohibited, then the prohibited character string variable 428 may also be used to specify the character string(s) to be used, the character position or location in the security token, and/or other information necessary to implement the prohibited string rules. As mentioned above for the mandatory character string variable 426, the prohibited character string variable 428 could point to or be influenced by a different variable, field, or data maintained by the system. For the examples shown in FIG. 4, the Token Types 1 and 2 do not specify any prohibited character strings. The Token Type 3, however, does specify at least one prohibited character string.

The minimum strength variable 430 may be used to designate a minimum strength, complexity, or security metric for the security tokens. Alternatively or additionally, the token format variables 410 could include a maximum strength variable to designate a maximum strength, complexity, or security metric for the security tokens. As used here, security token “strength” refers to how difficult or easy it might be to guess, decode, or otherwise illegitimately discover a security token. Thus, a simple three digit numerical PIN code is usually considered to be very weak, while a complex token having a mix of numbers, special characters, uppercase letters, and lowercase letters is usually considered to be very strong. In practice, the minimum strength variable 430 may accommodate any suitable scale or measurement scheme for security token strength. The examples shown in FIG. 4 utilize a strength scale of one to five, with increasing numbers corresponding to higher strength.

Referring now to the token use policy variables 412, the “maximum number of uses” variable 436 may be used to designate how many times a security token can be used before it is withdrawn, disabled, or revoked by the system. If specified, the value of the “maximum number of uses” variable 436 may be a defined number, a numerical range, or it may be linked to another variable or number maintained by the system. For the examples shown in FIG. 4, the Token Type 1 has no specified maximum number of uses and, therefore, security tokens of the Token Type 1 can be used an unlimited number of times. In contrast, security tokens of the Token Type 2 can only be used a maximum of five times, and security tokens of the Token Type 1 can only be used once.

The generation rate limit variable 438 designates a generation rate limit that caps the maximum number of unique security tokens that can be generated per defined period of time (e.g., per hour, per day, per month, or per any designated time period). The generation rate limit variable 438 can therefore be used to regulate the number of security tokens being generated over any specified period of time, to ensure that security is not compromised, to ensure that a potentially limited number of unique tokens do not get prematurely depleted, and the like. For the examples shown in FIG. 4, the Token Type 1 has a rate limit of ten per hour. Therefore, a maximum of ten security tokens of the Token Type 1 can be generated during any hour. In contrast, the Token Type 2 has a rate limit of four per day. Thus, a maximum of only four unique security tokens of the Token Type 2 can be generated during any day. The Token Type 3 has no rate limit imposed on it.

The “maximum number of failed attempts” variable 440 designates a retry limit that caps the maximum number of times an invalid or incorrect security token can be entered by a user or otherwise received for processing by the system. If utilized, the value of the “maximum number of failed attempts” variable 440 will be a nonzero number. For the examples shown in FIG. 4, the retry limit for security tokens of the Token Type 1 is five, the retry limit for security tokens of the Token Type 2 is two, and the retry limit for security tokens of the Token Type 3 is three. In one implementation, the system can revoke a security token after a configured number of failed attempts by the user to enter such a security token.

The expiration variable 442 designates an expiration time or lifespan of the security tokens, expressed in any suitable unit of time such as minutes, hours, days, weeks, years, etc. Upon expiration of a security token, the system may revoke that security token or otherwise render it invalid. For the examples shown in FIG. 4, security tokens of the Token Type 1 expire after one day, and security tokens of the Token Type 2 expire after twelve hours. In contrast, the Token Type 3 has no defined value for the expiration variable 442 and, therefore, tokens of the Token Type 3 have no stated expiration period.

It should be appreciated that the actual usable values corresponding to the various token configuration variables may be explicitly provided in the configuration data itself, or the values may be generated or otherwise derived in response to the configuration data. For example, the “maximum number of uses” variable 436 need not actually specify a numerical value. Instead, the maximum number of uses variable 436 could identify another variable or quantity that is otherwise maintained or used by the system. As another example, the maximum number of uses variable 436 may simply indicate “Yes/No” or “Active/Inactive” to enable the system to automatically determine the actual value to be used, based on an appropriate algorithm, formula, or preference settings. In accordance with one exemplary embodiment, however, at least some of the token configuration variables include predetermined and selectable entries/values associated therewith, and a user (e.g., an end user, a system administrator, a customer) can quickly and easily select specific values for the token configuration variables using, for example, a drop down control/selection element in a graphical user interface.

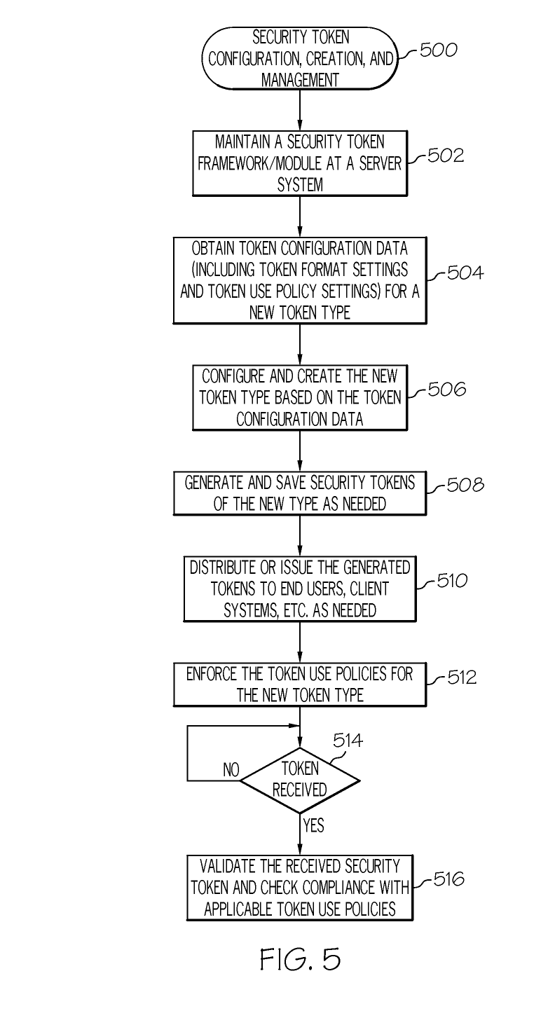

FIG. 5 is a flow chart that illustrates an exemplary process 500 related to the configuration, creation, and management of security tokens. The various tasks performed in connection with the process 500 may be performed by software, hardware, firmware, or any combination thereof In other words, the process 500 may represent a computer-implemented method to establish and manage security tokens for at least one application supported by a server system. In particular, the process 500 is executable by a suitably configured server system or a functional module of a server system, such as the security token framework described above. For illustrative purposes, the following description of the process 500 may refer to elements mentioned above in connection with FIGS. 1-4. In practice, portions of the process 500 may be performed by different elements of the described system, e.g., the security token module 202, the database 204, or the like. It should be appreciated that the process 500 may include any number of additional or alternative tasks, the tasks shown in FIG. 5 need not be performed in the illustrated order, and the process 500 may be incorporated into a more comprehensive procedure or process having additional functionality not described in detail herein. Moreover, one or more of the tasks shown in FIG. 5 could be omitted from an embodiment of the process 500 as long as the intended overall functionality remains intact.

The process 500 assumes that the server system has already been provided with the modules and functionality described above, e.g., the security token framework that creates token types, generates tokens, and handles received security tokens. In this regard, the process 500 maintains and operates the security token framework at a suitable server system or other computing architecture (task 502). When a new token type needs to be created, the process obtains or receives token configuration data (task 504) that preferably includes, conveys, or specifies values for at least some of the token configuration variables described above with reference to FIG. 4. In other words, task 504 obtains token format settings and token use policy settings for the new token type.

The precise manner in which the system obtains the token configuration data may vary from one embodiment to another, and it may vary in a particular embodiment from one operating scenario to another. For example, the token configuration settings/values could be received from a user of a client system that is supported by the server system and/or from a user of the server system itself In this regard, user-entered token configuration settings/values could be collected in a suitably formatted graphical user interface or web page and transmitted to the server system. The token configuration interface may be open and exposed to one or more end users, to authorized system administrators, to the software engineers responsible for writing and maintaining the code for the server system, etc. The token configuration data may be “packaged” or formatted in accordance with any known technique or technology. For example, the token configuration settings/values could be received at the server system in the form of an XML file, a configuration file, or any type of file structure that conveys the desired settings/values. As another example, the token configuration data for a new token type could be obtained with an update, revision, or initial install of the source code for the server system. In such a scenario, the security token framework need not be overwritten or otherwise altered. Rather, the source code update will merely provide additional token configuration data such that the existing security token framework can create the new token type.

With continued reference to FIG. 5, the process 500 responds to the token configuration data by configuring and creating a new token type, based upon the received configuration data (task 506). As described previously, the new token type is intended for use with at least one application supported by the server system, and the new token type will have a particular token format and a particular set of token use policies that are dictated or governed by the token configuration data. After the new token type is created, the process 500 can generate and save security tokens of the new token type as needed (task 508). Notably, each generated token will have a token format that is in compliance with the defined format for the new token type. Moreover, the generation of tokens may need to be in accordance with the stated token use policies.

If required by the particular application or function of the server system, the process 500 will distribute or issue the generated tokens to end users, client systems, processing modules of the server system, or the like, as needed (task 510). For example, the process 500 may need to send a security token (e.g., a PIN code, an identity confirmation password, or an encryption key) to a user so that the user can subsequently enter the security token to access a web page, to log into a protected resource, or the like. The process 500 may also be responsible for enforcing the various token use policies that apply to the newly created token type (task 512).

This example assumes that the security token framework eventually receives one or more incoming security tokens of the newly created type (the “Yes” branch of query task 514). In certain embodiments, incoming security tokens will be processed and checked for compliance with any applicable token use policies for that token type (task 516). In addition, incoming security tokens will be processed in accordance with one or more validation protocols to validate the incoming security tokens (task 516). If an incoming security token cannot be validated or the process 500 determines that the present circumstances indicate noncompliance with one or more of the defined token use policies, then the server system will take appropriate action, as is well understood.

The process 500 may be repeated any number of times to introduce new token types into the system, and to generate and process security tokens of different types. Moreover, although the process 500 has been described in the context of only one new token type, an embodiment could be executed in a manner that supports the creation of multiple token types in a simultaneous or concurrent manner.

As mentioned above, an exemplary embodiment of the system architecture may utilize a security token framework that introduces a token referred to as a “security token” that may be used for a variety of purposes such as identity confirmation challenge verification, phone verification, single sign-on, and the like. Notably, the security token can be highly configurable and, in one or more embodiments, vary in length, case sensitivity, the kinds of characters it contains (letters, numerals, special characters, etc.), lifetime, etc. In one implementation, the system can revoke a security token after a configured number of failed attempts by the user to enter such a security token. In addition, the system may implement rate limits that limit the maximum number of unique security tokens that can be generated per hour (or per any designated time period). Basically, the security token framework handles generation, verification, rate limiting, and revocation of security tokens.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method executable by a server system to establish and manage security tokens for at least one application supported by the server system, the method comprising:
creating, at the server system, a token type to be used with an application supported by the server system, the token type having a token format and a set of token use policies associated therewith, wherein the token format and the set of token use policies are dictated by obtained values of a plurality of token configuration variables;
generating, at the server system, a security token of the created token type and having the token format; and
enforcing, at the server system, the token use policies for the security token.

2. The method of claim 1, further comprising:
obtaining a received security token at the server system; and
validating the received security token.

3. The method of claim 1, further comprising:
obtaining a received security token at the server system; and
determining whether usage of the received security token complies with the token use policies.

4. The method of claim 1, further comprising:
receiving the obtained values of the plurality of token configuration variables from a client system supported by the server system.

5. The method of claim 1, further comprising:
receiving an XML file that conveys the obtained values of the plurality of token configuration variables.

6. The method of claim 1, further comprising:
receiving a configuration file that conveys the obtained values of the plurality of token configuration variables.

7. The method of claim 1, wherein the plurality of token configuration variables comprises a token format variable selected from the group consisting of: a token length variable, a case sensitivity variable, a numbers permitted variable, a letters permitted variable, a special characters permitted variable, a mandatory character string variable, a prohibited character string variable, and a minimum strength variable.

8. The method of claim 1, wherein the plurality of token configuration variables comprises a token use policy variable selected from the group consisting of: a maximum number of uses variable, a generation rate limit variable, a maximum number of failed attempts variable, and an expiration variable.

9. A computer-implemented method executable by a security token module of a server system to establish and manage security tokens for at least one application supported by the server system, the method comprising:
receiving token configuration data at the security token module, the token configuration data specifying a plurality of token format settings and a plurality of token use policy settings;
in response to receiving the token configuration data, the security token module creating a token type to be used with an application supported by the server system, the token type having a token format governed by the token format settings and the token type having a set of token use policies governed by the token use policy settings;
generating, at the security token module, security tokens in accordance with the token format; and
processing, at the security token module, incoming security tokens of the token type, wherein the processing is performed in accordance with the set of token use policies for the generated security tokens.

10. The method of claim 9, wherein the processing comprises validating the incoming security tokens.

11. The method of claim 9, wherein the token configuration data is received as user-entered data that originates from a client system supported by the server system.

12. The method of claim 9, wherein the token configuration data is received as user-entered data that originates from the server system.

13. The method of claim 9, wherein the token configuration data is received with an update of source code for the server system.

14. The method of claim 9, wherein the plurality of token format settings comprises a token format setting selected from the group consisting of: a token length setting, a case sensitivity setting, a numbers permitted setting, a letters permitted setting, a special characters permitted setting, a mandatory character string setting, a prohibited character string setting, and a minimum strength setting.

15. The method of claim 9, wherein the plurality of token use policy settings comprises a token use policy setting selected from the group consisting of: a maximum number of uses setting, a generation rate limit setting, a maximum number of failed attempts setting, and an expiration setting.

16. A computer-implemented server system comprising:
at least one application that utilizes security tokens;
a security token module configured to create token types for use with the at least one application, to generate security tokens corresponding to created token types, and to enforce token use policies for generated security tokens; and
a database to store generated security tokens for the security token module;
wherein the security token module is configured to accommodate creation of different token types having different token formats and different token use policies, based on obtained values of a plurality of token configuration variables;
wherein the security token module is configured to generate security tokens in accordance with the different token formats; and
wherein the security token module is configured to enforce the different token use policies when processing incoming security tokens of the different token types.

17. The server system of claim 16, wherein the obtained values of the plurality of token configuration variables originate from a client system supported by the server system.

18. The server system of claim 16, wherein:
the server system is a multi-tenant server architecture that supports a plurality of different tenants;
the database is a multi-tenant database for the multi-tenant server architecture; and
the security token module is a centralized module that supports the plurality of different tenants.

19. The server system of claim 18, wherein the security token module is configured to create at least one token type that is used across at least two of the plurality of different tenants.

20. The server system of claim 16, wherein the plurality of token configuration variables comprises variables selected from the group consisting of: a token length variable, a case sensitivity variable, a numbers permitted variable, a letters permitted variable, a special characters permitted variable, a mandatory character string variable, a prohibited character string variable, a minimum strength variable, a maximum number of uses variable, a generation rate limit variable, a maximum number of failed attempts variable, and an expiration variable.
